(19) United States
(12) Patent Application Publication
(10) Pub. No.: US 2016/0212449 A1
(43) Pub. Date: Jul. 21, 2016

(54) System and Method for Distributing Experience Based Content

(71) Applicant: Randall D. Satin, Scarsdale, NY (US)

(72) Inventor: Randall D. Satin, Scarsdale, NY (US)

(21) Appl. No.: 14/929,313

(22) Filed: Oct. 31, 2015

Related U.S. Application Data
(60) Provisional application No. 62/105,187, filed on Jan. 19, 2015.

(51) Int. Cl. H04N 21/214; H04N 21/254; H04N 21/2187; H04N 21/2543; H04N 21/4363; H04N 21/218; H04N 21/63

(52) U.S. Cl. CPC H04N 21/2143; H04N 21/21815; H04N 21/2541; H04N 21/632; H04N 21/2543; H04N 21/43637; H04N 21/2187

(57) ABSTRACT

A method and system for offering for sale and distributing the live recording of content is disclosed. First, the intellectual property rights to produce, copy, and distribute a live recording of content for sale is acquired. Thereafter, a plurality of computing devices suitable for network communication are configured to join a distribution network. The devices connected to the distribution network may be presented a time limited offer for sale of the live recorded content either during or after the event. After the expiration of the offer for sale, the live recorded content is unavailable to devices that did not accept the time limited offer for sale.

### CROSS-REFERENCE TO RELATED APPLICATION

This application claims priority to U.S. Provisional Application Ser. No. 62/105,187 filed Jan. 19, 2015, and entitled “System and Method for Distributing Experience Based Content,” which is hereby incorporated by reference in its entirety.

### TECHNICAL FIELD

The present invention relates generally to a business method that provides for the distribution of live recorded content.

### BACKGROUND OF THE INVENTION

The excitement of watching live events (i.e., concerts, sports, speeches, etc.) can be heighted when surrounded by other people. This is evidenced by the sale of memorabilia sold at live performances. Further, due to the unique nature of live performances, each performance and interaction during each live performance can vary. As a result, there is an impulse buying opportunity for live recorded content.

In view of the foregoing, there is a need for a system and method for distributing live recorded content for sale for a limited period of time.

In addition, a need exists for a system and method for distributing live recorded content utilizing a network.

A further need exists for a system and method that utilizes crowd sourcing to generate live recorded content for sale.

Social media networks have also become a popular platform for concert attendees to share their experience at a performance in real-time. It is estimated that at least 32% of concert attendees are posting their experience on social networks, while an estimated 47% of concert attendees are communicating using texting or e-mail. However, such posts are viewed by either friends or family members that are following the concert attendee, or individuals that are aware of the performance. As a result, it can be difficult for concert attendees to share their experiences with other similarly excited concert attendees, unless they are aware of each other. In addition, there are various different social media providers with different login requirements.

Therefore, there is a need in the art for a concert wall platform that allows audience members, content providers and the venue to interact with each other during a live recorded performance.

There is also a need for a common interface for concert attendees to post to various social media providers.

A further need exists to provide a learning algorithm that customizes a user experience over a period of time based upon their interaction with the concert wall platform.

### SUMMARY OF THE INVENTION

According to various embodiments of the present invention, a business method of offering for sale and distributing the live recording of content at a venue is disclosed. The intellectual property rights to produce, copy, and distribute a live recording of content for sale is acquired from the content rights holder. The venue comprises a content distribution platform that is coupled to an audio/video recording system. Audience members with computing devices suitable for network communication will have access to a distribution network made available at the venue. The distribution network can be secured to limit access to audience members present during the live recording at the venue. The live recorded content from the event is distributed to the devices in the distribution network. Audience members may be presented with a limited time offer to purchase the live recorded content either during or after the attendance of the event. At the end of the time period, the live recorded content is removed from the devices that did not accept the limited offer for sale.

### BRIEF DESCRIPTION OF THE DRAWINGS

The detailed description makes reference to the accompanying figures wherein:

FIG. 1 illustrates an exemplary network diagram;

FIG. 2 illustrates a venue in accordance with the preferred embodiment of the present invention;

FIG. 3 illustrates an exemplary user terminal;

FIG. 4 illustrates an exemplary content distribution system;

FIG. 5 depicts the process of purchasing a live recorded content from the content distribution system shown in FIG. 4;

FIG. 6 illustrates an exemplary interactive experience;

FIG. 7 illustrates an exemplary user terminal in accordance with another embodiment of the present invention;

FIG. 8 illustrates an exemplary venue;

FIG. 9 depicts a flowchart representing a music venue experience in accordance with the embodiment depicted in FIGS. 7-8; and

FIG. 10 illustrates an exemplary diagram of a foot race in accordance with an embodiment of the present invention.

Other objects, features, and characteristics of the present invention, as well as methods of operation and functions of the related elements of the structure and the combination of parts, will become more apparent upon consideration of the following detailed description with reference to the accompanying drawings.

### DETAILED DESCRIPTION OF THE PREFERRED EMBODIMENT

A detailed illustrative embodiment of the present invention is disclosed herein. However, techniques, methods, processes, systems, and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure.

None of the terms used herein, including “terminal,” “platform,” “portion,” and “segment” are meant to limit the application of the invention. The terms are used to illustrate the preferred embodiment and are not intended to limit the scope of the invention. Similarly, the use of these terms is not meant to limit the scope or application of the invention, as the invention is versatile and can be utilized in many applications, as will be apparent in light of the disclosure set forth herein.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, electronic or otherwise, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the Detailed Description of the Preferred Embodiment using the singular or plural number may also include the plural or singular number respectively. The word “or,” in reference to a list of two or more items, covers all of the following interpretations of the word: any of the items in the list, all of the items in the list, and any combination of the items in the list. The following presents a detailed description of the preferred embodiment of the present invention with reference to the figures.

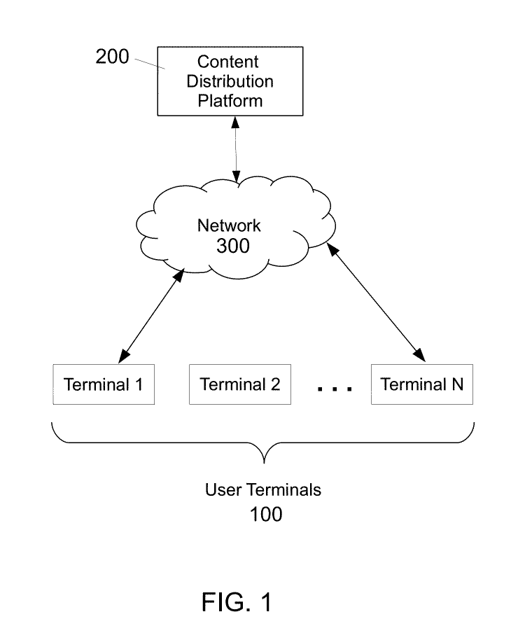

Referring initially to FIG. 1, shown is an exemplary network diagram for distributing live recorded content to user terminals. Generally, content distribution platform 200 can be implemented on hardware or a combination of hardware and software. In some embodiments, the techniques disclosed herein are implemented in a software environment such as an operating system or in an application running on an operating system. This software can include, but is not limited to, resident software, firmware, etc., or can be implemented on a cloud-based or visualized network system.

User terminals 100 communicate over network 300 with content distribution platform 200. In the preferred embodiment, content distribution platform 200 distributes live recorded content. User terminal 100 is preferably a smartphone, but can comprise any personal electronic device including, but not limited to, a mobile telephone, cellular telephone, smart watch, laptop computer, netbook, personal digital assistant (PDA), tablet, or any other computing device suitable for network communication.

Network 300 can be a local area network (LAN), a wide area network (WAN), the Internet, cellular networks, satellite networks or any other network that permits the transfer and/or reception of data to and/or from user terminals 100. The data transmitted to or from user terminals 100 and content distribution platform 200 through network 300 can be transmitted and/or received utilizing standard telecommunications protocol or standard networking protocol. In the preferred embodiment, the system utilizes Transmission Control Protocol/Internet Protocol (TCP/IP) and network 300 is a local network. Other examples of protocols for transmitting and/or receiving data include but are not limited to Voice Over IP (VOIP) protocol, Short Message Service (SMS), and Global System for Mobile Communications (GSM). Network 300 is capable of utilizing one or more protocols of user terminals 100. Furthermore network 300 can translate to or from other protocols to one or more protocols of user terminals 100.

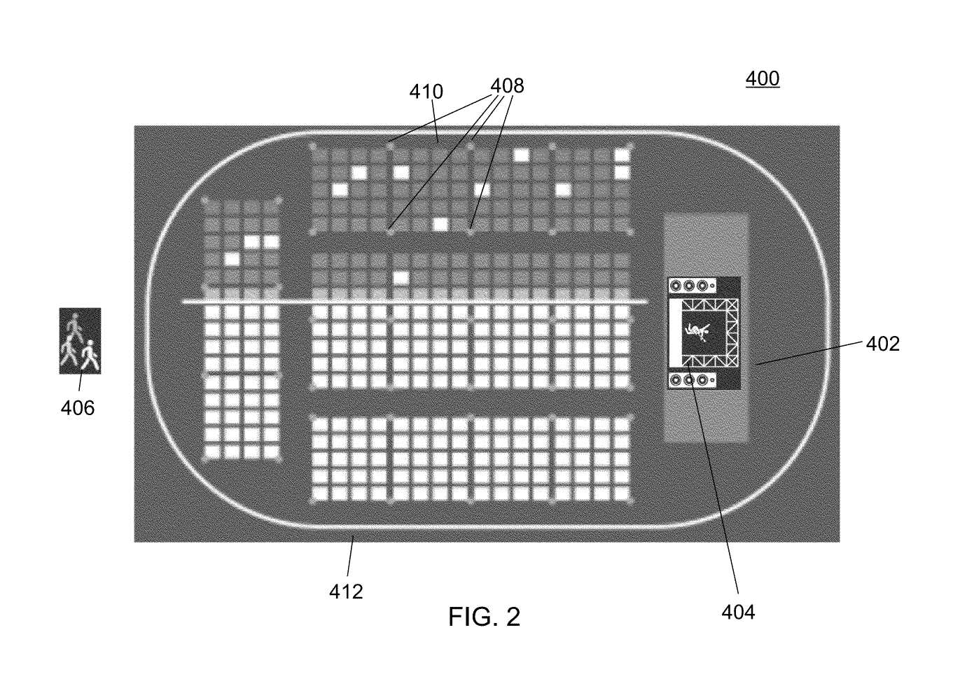

Referring now to FIG. 2, shown is a diagram of music venue 400 that utilizes the preferred embodiment of the present invention for distributing live recorded music and video. Venue 400 comprises stage 402 and audience section 412. Content provider 404 (in this case a musical group) performs live music on stage 402. Audience members 406 listen to the live music from audience section 412. In the preferred embodiment, audience section 412 includes at least one grid 410. As shown, the perimeter of grid 410 is defined by at least one beacon 408 (in this case four to define a square). Beacon 408 is preferably a Bluetooth® low energy beacon and utilized to track the position of audience member 406 within each grid 410. While the perimeter of grid 410 is depicted as a square, other shapes may be used to define the perimeter of a grid.

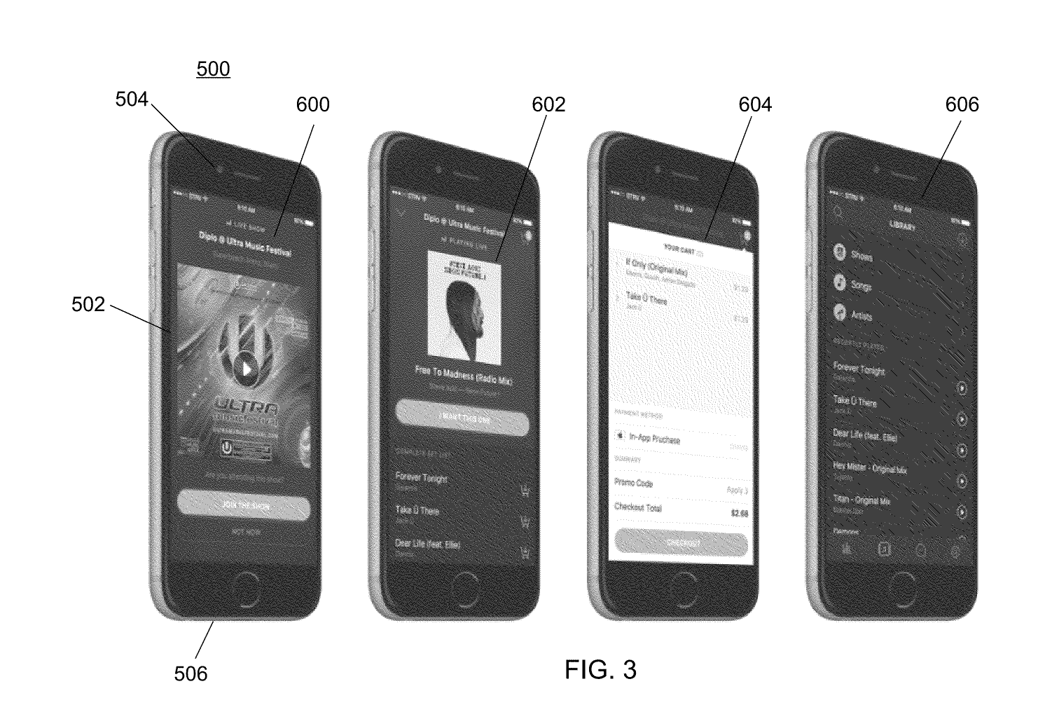

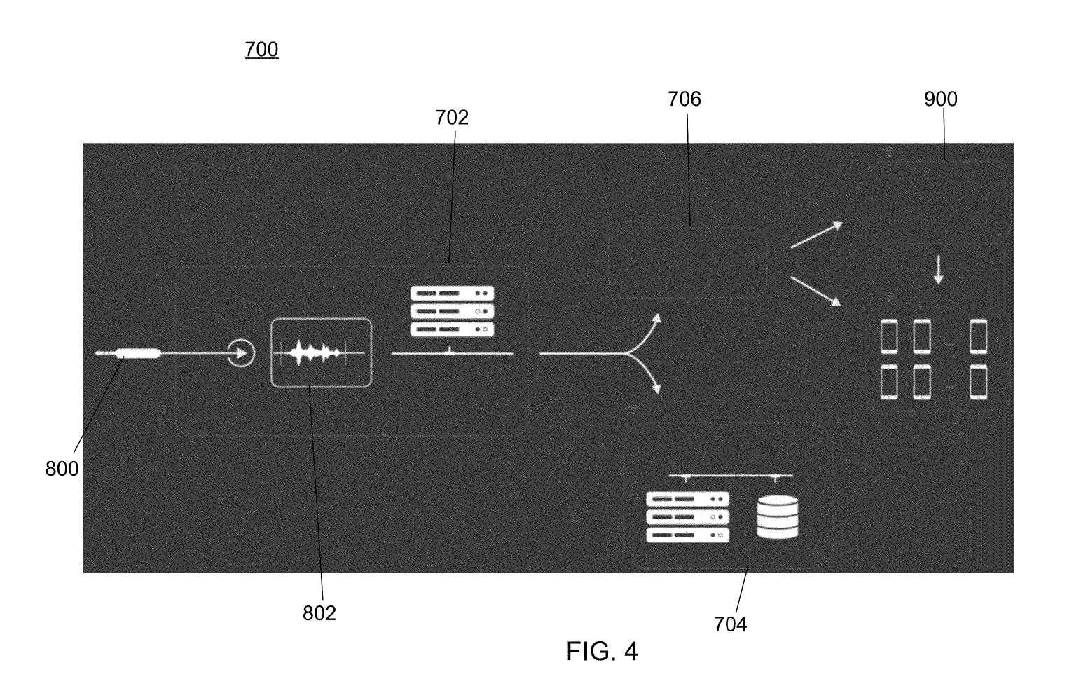

In the preferred embodiment, the position of an audience member is tracked at venue 400 with an application running on a user terminal. As shown in FIG. 3, audience members download an application on user terminal 500, for example a smartphone, in order to interact with the business method of distributing live recorded content of the present invention. This can occur prior to and when the audience member arrives at the venue. User terminal 500 comprises user interface 502, which is configured to display presentation screens. Initially, presentation screen 600 is displayed on user interface 502 and prompts the audience member to join the event at the venue. As described in detail below with reference to FIG. 4, presentation screen 602 is displayed to notify an audience member when live recorded content at the venue is available for purchase. Presentation screen 604 depicts an exemplary interface for purchasing the live recorded content, while presentation screen 606 depicts an interface to organize and play the user's purchased live recorded content. User terminal 500 further includes a camera 504 and microphone 506.

Turning next to FIG. 4, content distribution platform 700 comprises first storage 702. First storage 702 includes a server and comprises high speed storage and network connection capabilities. First storage 702 is preferably located at the venue. As shown in FIG. 4, live recorded content 802 from a live audio and/or video feed 800 is stored on first storage 702 by content distribution platform 700. Live audio and/or video feed 800 is preferably provided from at least one mixing board located at the venue. Thereafter, live audio and/or video feed 800 is cut and edited to form live recorded content 802. The editing process of live audio and/or video feed 800 can be performed by an individual or automatically. Thereafter, live recorded content 802 is optimized utilizing known encoding techniques in the art and stored on first storage 702. In addition, metadata comprising title, play time, date/time created, and artist name can be stored with live recorded content 802.

Content distribution platform 700 further comprises second storage 704. Second storage 704 includes a server comprising storage and network connection capabilities. In the preferred embodiment, second storage 704 is not directly coupled to live audio and/or video feed 800. First storage 702 transfers live recorded content 802 over a network to second storage 704. In addition, first storage 702 indicates that live recorded content 802 is available for purchase.

As shown in FIG. 4, notification service 706 of content distribution platform 700 sends a notification to user terminals 500 located at the venue. The notification presents user terminal 500 with an offer to purchase live recorded content 802, as shown in presentation screen 602 of FIG. 3. In addition, notification service 706 notifies service provider 900 that live recorded content is available for purchase. Service provider 900 allows a user to download the application that interacts with the content distribution platform. Service provider 900 sends a notification to user terminals that a live recorded content is available to purchase.

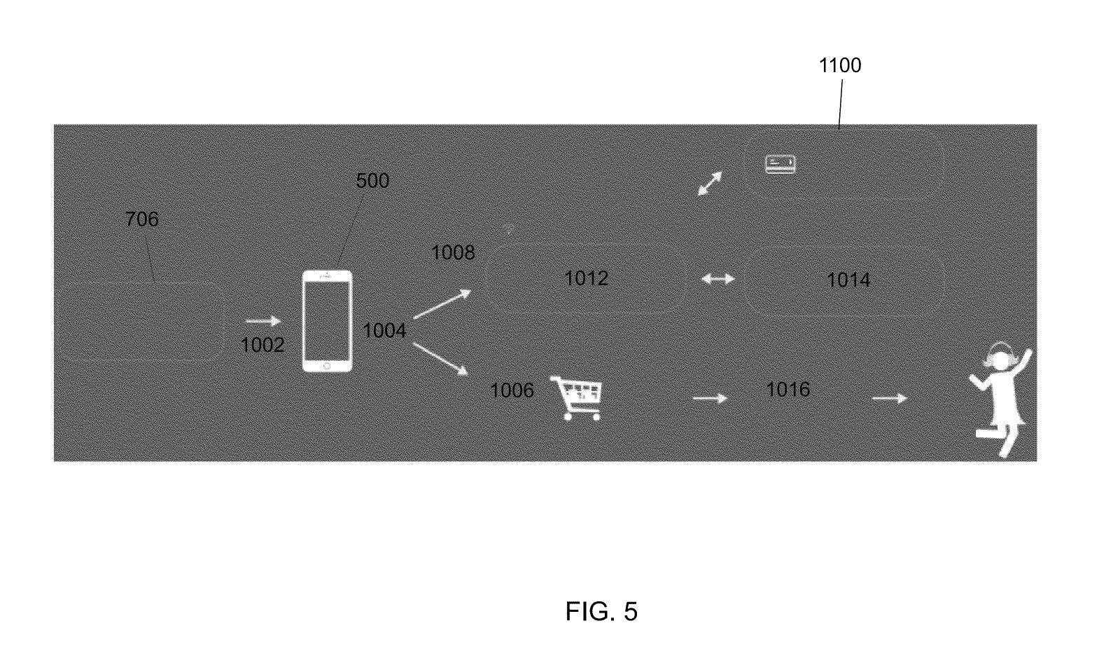

FIG. 5 depicts an exemplary process of purchasing live recorded content from the content distribution platform. First in step 1002, notification service 706 of the content distribution platform notifies user terminal 500 that a live recorded content is available for purchase. Next, in step 1004, the user determines whether to immediately purchase the live recorded content or to wait. In step 1008, the user has selected to immediately purchase the live recorded content. Prior to the completion of the purchase, the user's payment information is verified and updated if necessary in step 1012. Next in step 1014, the user's payment is processed through payment system 1100. A record of the purchase is stored with the user's account in the content distribution platform. However, in step 1006, the user has selected to wait to purchase the live recorded content. During or after the performance, the user can proceed to step 1008 to complete the purchase of the live recorded content as described above. Finally, in step 1016 the user can download the live recorded content to their user terminal and enjoy the live recorded content that they completed purchasing.

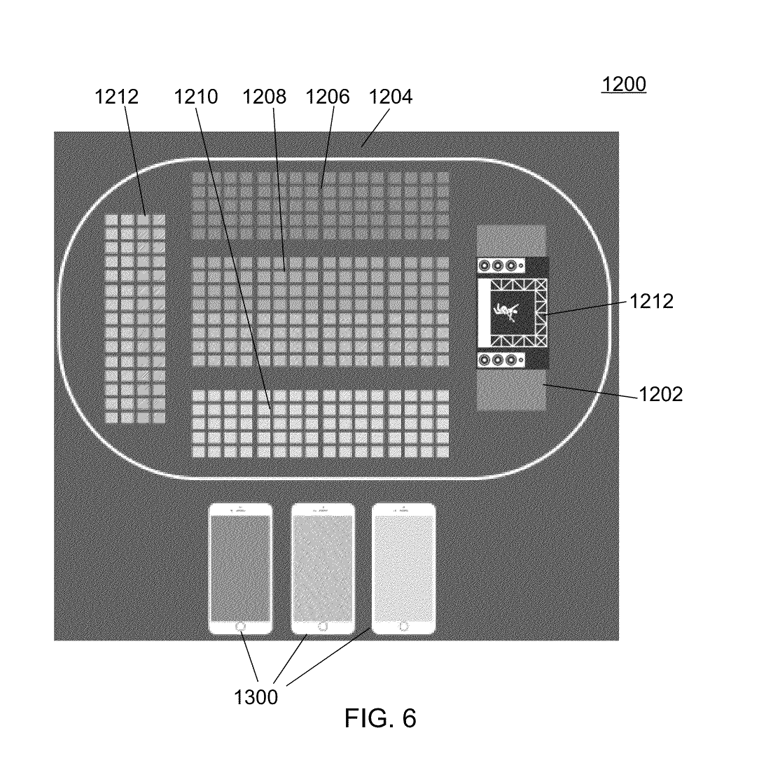

In addition to allowing an audience member to purchase live recorded content, the present invention provides an interactive experience for audience members. Turning next to FIG. 6, shown is venue 1200. Venue 1200 comprises stage 1202 and audience section 1204. Audience section 1204 is divided into grids 1206, 1208, 1210, and 1212 as described in detail above with reference to FIG. 2. During the performance, content provider 1214 can direct the presentation screen of user terminals 1300 running an application to display a first color, second color, or third color. The color can depend on the location of the user terminal in grids 1206, 1208, 1210, and 1212. As a result, the content provider can include the audience members in a coordinated light show. In some embodiments, this light show can be included with the live recorded content.

Further, the present invention allows content providers and audience members to interact throughout the performance. Prior to the performance, an embodiment of the present invention can stream backstage video and/or audio footage of a content provider preparing to perform to the user terminals. This behind the scenes live recorded content is exclusive to the audience members at the venue. The content provider can interact with audience members by enabling polls on the user terminals that allow audience members to select the order of the setlist or costumes to wear. Also, the content provider can send exclusive messages (i.e. pictures, messages, and/or video) to the audience members. As the content provider performs, additional polls can allow audience members to dynamically change the setlist of the performance. Finally at the conclusion of the performance, audience members can select the encore song. As a result, audience members are engaged throughout the performance with content that is exclusive to the individuals at the venue.

In addition to connecting content providers with audience members, the embodiment of the present invention provides for a concert wall platform for audience members to share their experiences with other audience members. Generally, the concert wall platform requires audience members to register an account. An audience member can register utilizing either their credentials from known social network providers or directly sign up for a new account. The profile of the audience member can store the login information for the audience member's various social media provider accounts. As a result, the audience member can communicate through various social media profiles using a common interface. When an audience member enters a venue, they are prompted to join the concert wall for the current event. In the preferred embodiment, the concert wall platform allows audience members, content providers, and the venue to access all of the posts taken during the concert to the concert wall platform. As a result, an audience member at the rear of the stage can see posts from audience members near the front of the stage. As described above, the content provider can post a video, message, or photo to the concert wall that is exclusive to audience members in the venue.

The concert wall platform provides several advantages to venues. First, the concert wall platform allows venues to advertise upcoming performances and provide discounts to audience members. Second, the concert wall allows venues to track analytics based on the photos, videos, and comments posted by audience members to the concert wall platform during the performance. As a result, a venue can determine adjustments to make to increase the positive experience of audience members at the venue.

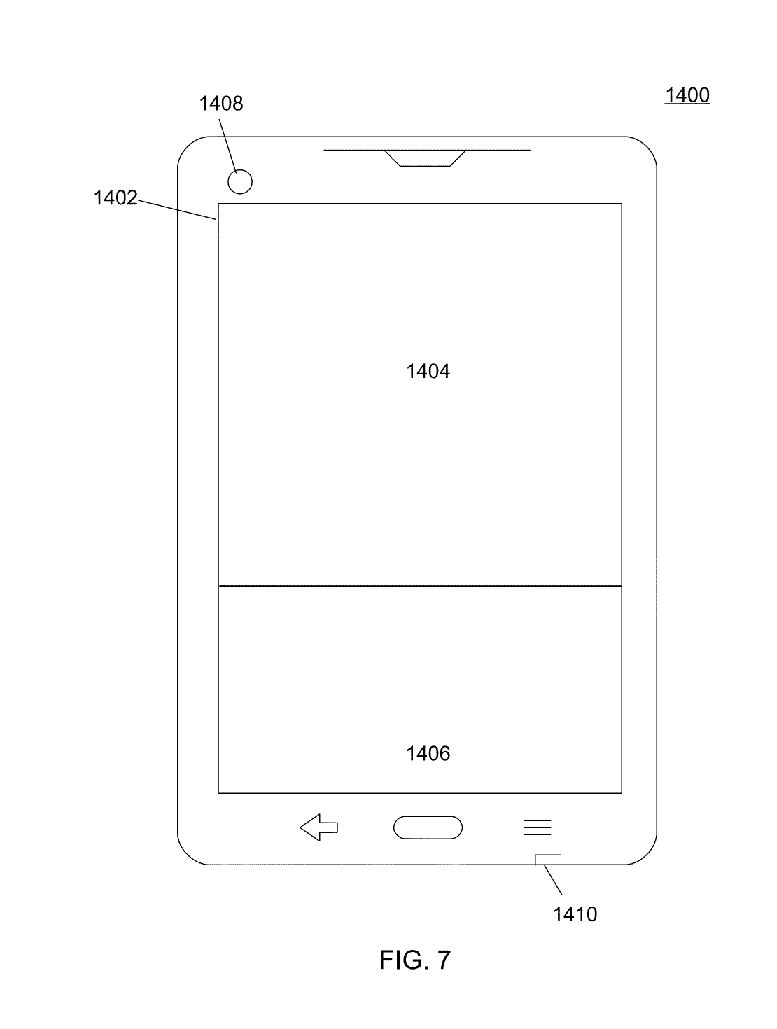

FIG. 7 depicts an exemplary embodiment of the present invention that utilizes peer to peer networking to distribute live recorded content. User interface 1402 is displayed on user terminal 1400. User terminal 1400 is preferably a smartphone, but can comprise any personal electronic device including, but not limited to, a mobile telephone, cellular telephone, smart watch, laptop computer, netbook, personal digital assistant (PDA), tablet, or any other computing device suitable for network communication. User interface 1402 comprises a top portion 1404 and a bottom portion 1406. Live recorded content is displayed on top portion 1404. The title of the content is displayed on top portion 1404 for audio only content. In this embodiment, a user is given a limited period of time to purchase the content displayed on top portion 1404. In other embodiments, real-time information, such as the time remaining to purchase, total number of purchases, and trending social media comments about the event is overlapped on top portion 1404 to encourage a user to purchase the content. Bottom portion 1406 of user interface 1402 can display targeted advertisements and can be utilized to include the user terminal in a collective effect, for example, a light show. User terminal 1400 further includes a camera 1408 and microphone 1410 that allows a user to record content to distribute to other user terminals.

User terminal 1400 communicates over a network as described above with a content distribution platform. In this embodiment, the content distribution platform utilizes peer to peer networking to distribute live recorded content. For example, the content distribution platform can direct a first user terminal to communicate with a second user terminal to distribute a segment of the live recorded content stored on the second user terminal. Further, the content distribution platform can direct the first user terminal to communicate with a plurality of other user terminals and/or the content distribution platform to distribute additional segments of the live recorded content. In turn, the segments of the live recorded content stored on the first user terminal can be directed by the content distribution platform for distribution to other user terminals. As a result, the user terminal 1400 can utilize multiple sources to distribute the live recorded content. This design is advantageous to a centralized source that can comprise a limited number of concurrent connections. The user terminals are configured to concatenate the various distributed segments of the live recorded content and display the live recorded content on the user interface of the user terminal. In this embodiment, the live recorded content is deleted after a period of time to purchase the live recorded content expires.

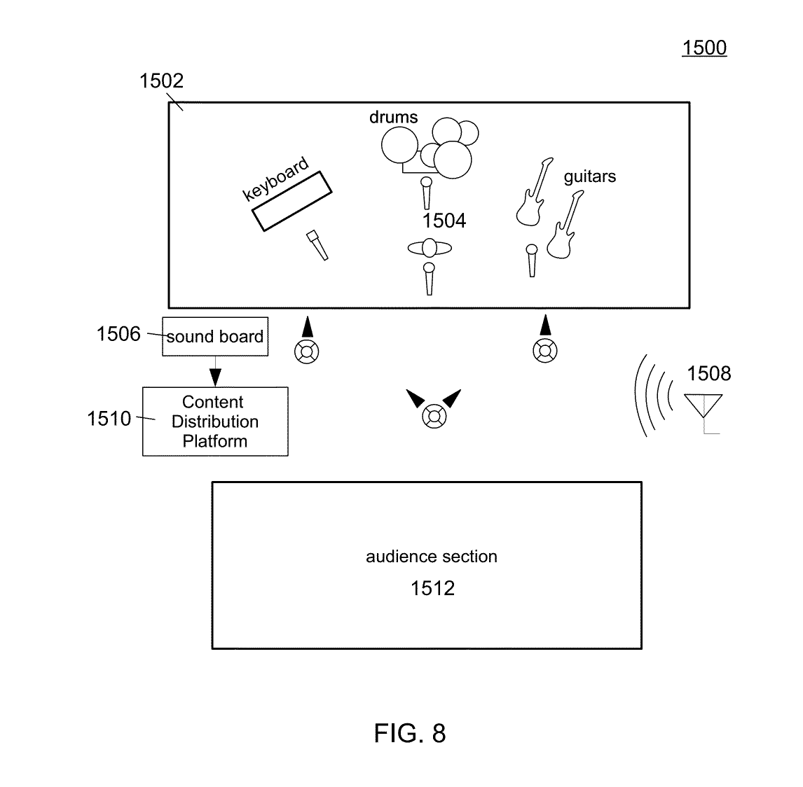

Referring now to FIG. 8, shown is a diagram of music venue 1500 that utilizes another embodiment of the present invention for distributing live recorded music. Venue 1500 comprises stage 1502 where content provider 1504 (in this case a musical group) performs live music. The musical instruments of content provider 1504 are coupled to sound board 1506 to record the highest quality sound. In addition, venue 1500 comprises various mics, for example, house mics to record vocals, and directional mics (including cardioid mics) to record instruments. These various microphones are coupled to soundboard 1506. Soundboard 1506 processes the various live recordings, which content distribution platform 1510 distributes over network 1508. In this embodiment, network 1508 is a LAN and access to network 1508 is limited to audience members present during the live performance. Audience members in audience section 1512 are prompted on their user terminal with a timed offer for sale of the live recorded music.

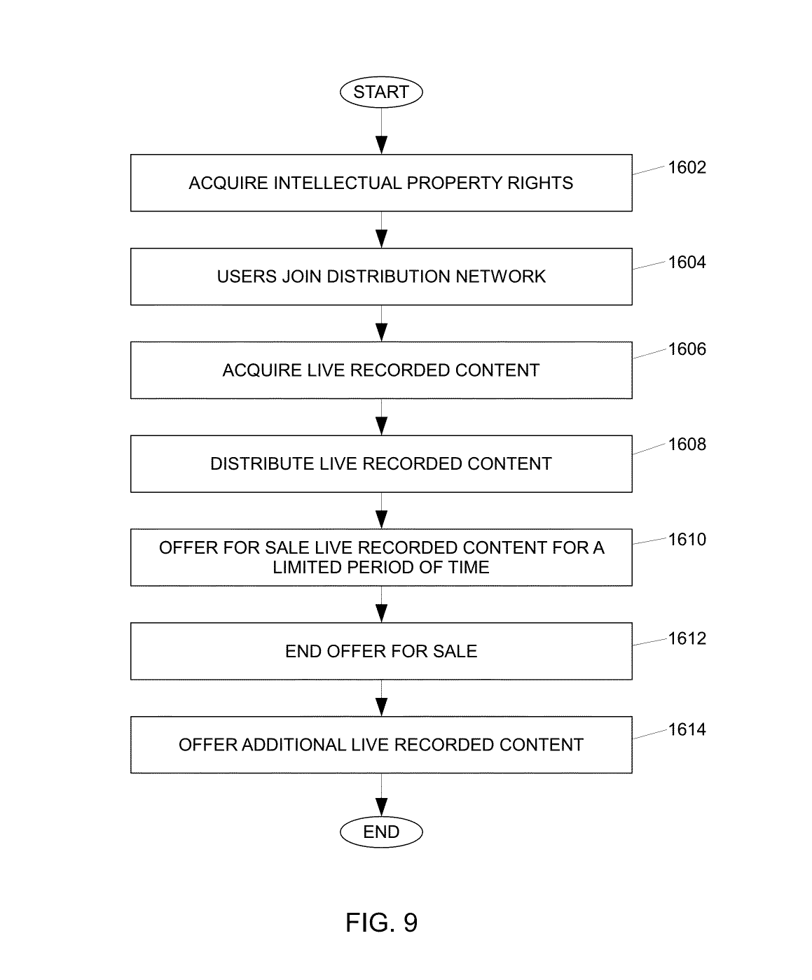

FIG. 9 depicts a flowchart representing a music venue experience in accordance with the embodiment described in detail above with reference to FIGS. 7-8. First, in step 1602, the intellectual property rights to produce, copy, and distribute a live recording of music for sale are acquired. In this embodiment, the content distribution platform acquires a license to an intellectual property database comprising the intellectual property rights to produce, copy, and distribute various live recordings of music for sale. The intellectual property database is periodically updated with additional rights related to live recording of music. The content provider can also directly license their intellectual property rights to the content distribution platform.

Next, in step 1604, audience members arrive at the music venue. Audience members with devices suitable for network communication, for example a smartphone, are prompted to join a network at the venue. In this embodiment, an audience member enters a unique passcode that is generated by the venue on the date of the performance. The unique code limits the availability of the live recorded content to members within the venue space. In another embodiment, the venue can include transmitters at its entrances to automatically grant access to its network. In addition, the audience member's user terminal joins a peer-to-peer network for distributing the live recording of music at the venue. The audience members that join the distribution network are provided with a limited license to the intellectual property rights acquired in step 1602. The distribution network can be a local area network (LAN), a wide area network (WAN), the Internet, cellular networks, satellite networks or any other network that permits the transfer and/or reception of data to and/or from the user terminals.

Next, in step 1606, the content provider performs a song. The soundboard at the venue directly records the devices, including the instruments and microphones that are connected to the soundboard.

In step 1608, the soundboard recording of the live music is distributed to the audience members' smartphones that joined the peer-to-peer network of the content distribution platform. In this embodiment, the content distribution platform is directly connected to the soundboard. In other embodiments, the content distribution platform can be located offsite from the venue. As a result, the content distribution platform communicates with the soundboard (or a device with network capabilities attached to the soundboard) and the smartphones to distribute the live recorded content from the venue.

Next in step 1610, the audience members are offered for sale the live recorded content for a limited period of time, for example 60 seconds. The revenue from a sale is preferably distributed 50% to the performing artist, 25% to the venue, and 25% to the content distribution platform. In step 1612, the offer for sale is terminated and the distributed live recorded content is removed from the audience members' smartphones that did not accept the offer for sale in step 1610.

In step 1614, another limited offer for sale is presented to the audience member for another live recorded content. Steps 1606 to 1612 are repeated until the performance is complete.

In addition to distributing live recorded content, this embodiment of the present invention can distribute instructions to coordinate audience members in a collaborated effect. For example, the content distribution platform can map the position of each smartphone that has joined the distribution network. Thereafter, the audience members at specific locations receive instructions to perform an act or to raise their phone in a complete light show. Furthermore, the audience members can be prompted to record audio using the microphone of their smartphone. Thereafter, the audio can be included in the live performance.

While the preferred embodiment is disclosed in the context of a music venue, the principles disclosed herein may be used in other environments as well. For example, the distribution of live recorded content may be adapted to video content at a football game. The content distribution platform can acquire the intellectual property rights to distribute for sale the live recording of football highlights that are typically shown to a television audience. Thereafter, spectators at the stadium can purchase these highlights using the content distribution platform. Further, the content distribution platform can allow spectators to anonymously distribute photos taken at the football game for other spectators to purchase for a limited period of time. The content distribution system can also notify spectators about deals and the condition of the lines at nearby food vendors. In one embodiment, the content distribution platform tracks the position of food vendors moving throughout the stadium and notifies spectators of the food vendors' locations and estimated time of arrival to the spectator's position.

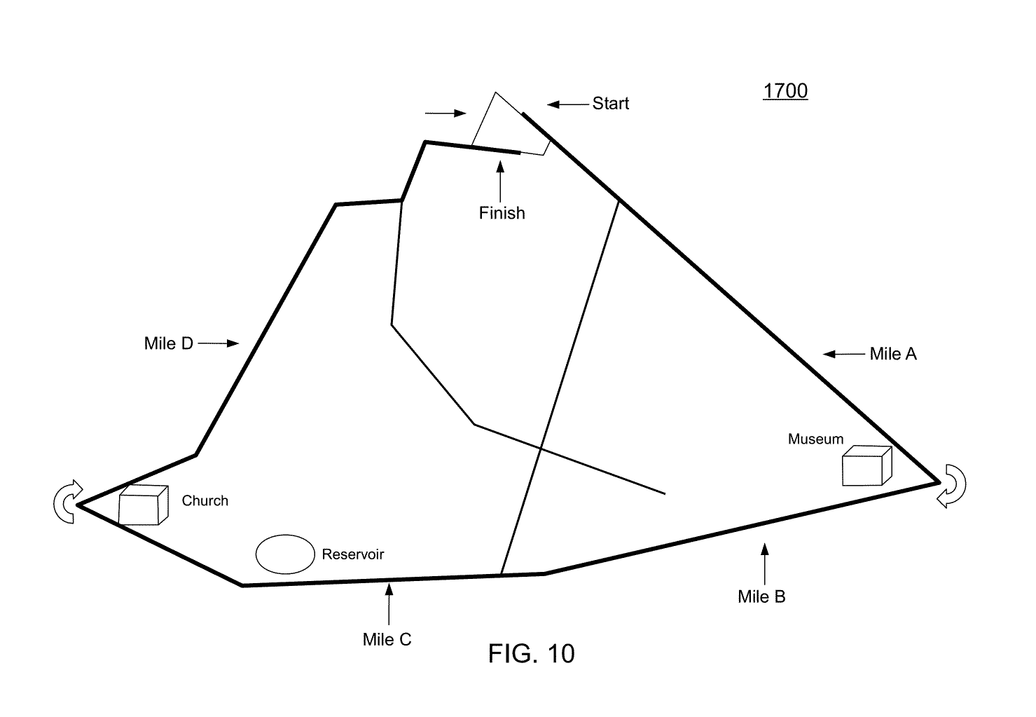

Referring now to FIG. 10, shown is a diagram of foot race 1700 that utilizes the present invention for distributing live photos of runners. As a condition for entering the race, a runner grants the intellectual property rights to produce, copy, and distribute live recordings of the runner for sale to the content distribution platform. In addition, the content distribution platform acquires the intellectual property rights to produce, copy, and distribute a live recording of spectators at the race. Spectators with a device suitable for network communication, in this case a smartphone, are prompted to join a distribution network at the race event for purchasing and selling live photos and video recording of the runners.

Typically, signs are posted throughout a race, for example at Mile A, Mile B and Mile C, to indicate the mile marker of the race and to advertise the sponsors of the race. The content distribution platform of the present embodiment provides dynamic advertisement on a spectator's smartphone. This is advantageous from conventional signs that have limited space. Further, the advertisements can be targeted based on the location of the spectator and the sponsor. For example, a restaurant can advertise specials for nearby spectators on their smartphone.

At various locations of the race, spectators can record photos or videos of runners using their smartphones. In this embodiment, the content distribution platform allows spectators to distribute photos. The spectator is given a limited period of time after taking a photo to anonymously distribute the photo through the content distribution platform for other spectators to purchase. Information on the identity of the runners in the photo and the location is embedded in the photo. In this embodiment, a running tracking system, for example, one that utilizes passive or active transmitters is utilized to determine this information. In another embodiment, runners can carry an active transmitter that smartphones connected to the distribution network can track and share information location throughout the race. Spectators preferably configure the photos presented on their smartphone to runners that they are tracking Such photos are presented for a limited period of time. During the limited time, the spectator can purchase, comment, and/or pass on the photo. Purchasing or passing on a photo presents the next photo for the spectator to purchase for a limited time. In this embodiment, spectators are incentivized to submit high quality photos, because positive comments increase the number of concurrent images that they can submit for distribution. In addition, each photo sold provides a credit for the spectator's account to use for purchasing other live recordings at the event or other events utilizing the content distribution platform.

Further, in this embodiment a spectator can request that other spectators cheer or take photos of a runner that they are tracking Spectators can configure their smartphone to receive notices to cheer or take photos of a runner. The content distribution platform uses geolocation to determine the position of the spectators connected to the distribution network. The spectators are assigned to groups to optimize cheering and photos collected. For example, certain spectators at Mile A are notified to cheer for a runner while other spectators are notified to take photos. A runner tracking system notifies each spectator when a runner that they are assigned to cheer or take a photo is approaching. The spectators that utilize this notice system are charged a fee and given the opportunity to support their runner throughout the race instead of only a few locations. Although this embodiment has been described for spectators, a runner carrying a network device can also configure their device to receive photos and notifications.

While the present invention has been described with reference to the preferred embodiment, which has been set forth in considerable detail for the purposes of making a complete disclosure of the invention, the preferred embodiment is merely exemplary and is not intended to be limiting or represent an exhaustive enumeration of all aspects of the invention. Numerous changes may be made in such details without departing from the spirit and the principles of the invention. The present invention is capable of being embodied in other forms without departing from its essential characteristics.

What is claimed is:

1. A method of offering for sale a substantially real-time recording of content, comprising the steps of:
connecting a plurality of devices to a distribution network;
acquiring a substantially real-time recording of content;
offering the substantially real-time recording of content for sale for a limited period of time; and
processing a sale of the substantially real-time recording of content.

2. The method of claim 1, further comprising the step:
acquiring intellectual property rights to produce, copy, and distribute the substantially real-time recording of content for sale.

3. The method of claim 1, wherein the step of acquiring a substantially real-time recording of content, further comprises the steps:
acquiring a substantially real-time audio or video feed at a venue; and
editing the substantially real-time audio or video feed to form the substantially real-time recording of content.

4. The method of claim 3, further comprising the step:
optimizing the substantially real-time recording of content.

5. The method of claim 1, wherein the step of connecting a plurality of devices to a distribution network, further comprises the step:
authenticating access to the distribution network.

6. The method of claim 1, wherein the step of processing a sale of the substantially real-time recording of content, further comprises the steps:
storing the offer for sale for a limited period of time; and
processing the stored offer for sale.

7. The method of claim 1, wherein the step of connecting a plurality of devices to a distribution network, further comprises the step:
connecting the plurality of devices to a peer-to-peer network.

8. The method of claim 7, further comprising the steps of:
distributing the substantially real-time recording of content to the plurality of devices; and
removing the substantially real-time recording of content from the distribution network after the limited period of time.

9. A method of offering for sale a substantially real-time recorded content, comprising the steps of:
connecting a plurality of devices to a distribution network;
forming at least one grid;
acquiring a substantially real-time recording of content;
offering the substantially real-time recording of content for sale for a limited period of time; and
processing a sale of the substantially real-time recording of content during the limited period of time.

10. The method of claim 9, further comprising the step:
tracking the plurality of devices.

11. The method of claim 9, further comprising the step:
transmitting substantially real-time content to the plurality of devices.

12. The method of claim 10, further comprises the steps:
synchronizing an effect based on a location of each plurality of devices in the at least one grid.

13. The method of claim 9, further comprising the steps:
interacting with the plurality of devices;
adjusting a substantially real-time content based on an interaction with the plurality of devices.

14. The method of claim 12, further comprising the step:
offering the effect for sale for a limited period of time.

15. A substantially real-time content distribution system comprising:
a plurality of devices;
a venue comprising at least one grid;
at least one storage comprising high speed storage and network connection capabilities;
at least one substantially real-time recorded content; and
a distribution network.

16. The system of claim 15, wherein the at least one grid comprises at least one Bluetooth beacon.

17. The system of claim 15, wherein the venue comprises at least one mixing board and the at least one mixing board is coupled to the at least one storage.

18. The system of claim 15, wherein the substantially real-time recorded content comprises metadata.

19. The system of claim 15, wherein the least one storage comprises:
a first storage located at the venue; and
a second storage located outside of the venue.

20. The system of claim 19, further comprising a payment system.
